(19) United States
(12) Patent Application Publication
(10) Pub. No.: US 2008/0027876 A1
(43) Pub. Date: Jan. 31, 2008

(54) SYSTEM AND METHOD FOR PREPARING PREMARITAL AGREEMENT

(75) Inventor: Yang-Woon Lim, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: GL Law Firm, Seoul (KR)

(21) Appl. No.: 11/745,989

(22) Filed: May 8, 2007

Related U.S. Application Data
(63) Continuation of application No. PCT/KR04/02875, filed on Nov. 8, 2004.

(51) Int. Cl. H04L 9/00

(52) U.S. Cl. 705/76

(57) ABSTRACT

The present invention relates to a system and method for preparing a prenuptial agreement using a communication network. The present invention receives a request for preparing a prenuptial agreement from one or more user terminals, sends the pertinent information for married life to a user terminal through a communication network, receives a request for provision of a proposed draft from a user terminal, sends a pre-stored proposed draft for prenuptial agreement to a user terminal, creates a draft for prenuptial agreement by including articles corresponding to a request for insertion of articles in a proposed draft for prenuptial agreement if insertion of articles is requested, and sends a draft for prenuptial agreement to a user terminal. Therefore, the marrying parties can prepare a prenuptial agreement, including provisions for pursuing happy marriage, more easily on-line.

### CROSS-REFERENCE TO RELATED APPLICATIONS

This application is a continuation application, and claims the benefit under 35 U.S.C. §§ 120 and 365 of PCT Application No. PCT/KR2004/002875, filed on Nov. 8, 2004, which is hereby incorporated by reference.

### BACKGROUND OF THE INVENTION

The present invention is directed to a system and method of preparing a prenuptial agreement, more specifically to a system and method of preparing a prenuptial agreement using a communication network for a happy marriage by enabling fulfillment of agreements made before the marriage.

### FIELD OF THE INVENTION

Marriage is one of the most important life events for anyone. The wedding ceremony, particularly, is the most splendid event in which two people vow their commitment to each other in front of many witnesses.

One of the services related to marriage is a matchmaking service, provided for those who are seeking their ideal spouse. Some of these services currently available over the Internet include Neowiz (http://www.saycupid.com) and Duo (http://www.duo.co.kr). They receive from the user some personal information, such as name, address, resident registration number, contact number, education, height, and occupation, which is used to determine the compatibility with other users and mediate an opportunity for both parties to meet with each other in case matching parties are discovered through a search. The matchmaking services provided over the Internet are increasingly specialized through limiting the eligibility of membership and diversifying the method of matchmaking.

However, these conventional service, although diverse and improving, have been only bridging two parties who desire to find a potential spouse and not been able to guarantee a happy marriage. In other words, what seemed to be possible to overcome through the power of love before the marriage is often overwhelmed by the significance of reality after the marriage, creating conflicts and disputes.

Moreover, even if both parties desires to prepare an agreement in writing, before the marriage, on their commitments after the marriage, the discussion or negotiation is made by both parties only, and consequently many important matters are often not included. Besides, since the agreement is not certified by a third party, the stipulation becomes weaker over time.

### DESCRIPTION OF THE RELATED ART

This invention, contrived to solve aforementioned problems, aims to provide a system and method of preparing a prenuptial agreement using a communication network such that marrying parties can readily prepare a prenuptial agreement that includes details needed for a happy marriage.

This invention also aims to provide a system and method of preparing a prenuptial agreement using a communication network such that the prenuptial agreement prepared by the marrying parties is review by an attorney and/or certified by a law firm to strengthen the reliability of the prenuptial agreement and curb the weakening of commitment by each of the marrying parties.

Another objective of this invention is to provide a system and method of preparing a prenuptial agreement using a communication network such that marrying parties enter into a responsible marriage after learning grounds for happy marriage.

Another objective of this invention is to provide a system and method of preparing a prenuptial agreement using a communication network such that irresponsible moving-in or de facto marriage can be prevented by explicitly laying out the responsibilities and obligations for those who are considering moving in together or having a de facto marriage or those who have already moved in or are in a de facto marriage relationship.

### SUMMARY OF THE INVENTION

In order to solve aforementioned problems, an aspect of this invention provides a method of preparing a prenuptial agreement in a prenuptial agreement preparing system connected to one or more user terminals through a communication network, the method comprising: receiving a request for preparing a prenuptial agreement from one or more user terminals; sending information for married life corresponding to a request for provision of information for married life, received from the user terminal, to the user terminal through a communication network; receiving a request for provision of a proposed draft for prenuptial agreement from the user terminal; sending a pre-stored proposed draft for prenuptial agreement to the user terminal; receiving a request for insertion of articles from the user terminal; creating a draft for prenuptial agreement by including articles corresponding to the request for insertion of articles to a proposed draft of prenuptial agreement; sending the draft for prenuptial agreement to the user terminal; receiving complementation or a request for revision from the user terminal on the draft for prenuptial agreement; creating a revised draft for prenuptial agreement corresponding to the complementation or the revision request; and sending the revised draft for prenuptial agreement to the user terminal, as well as a system, device, and recorded medium enabling the execution of the method for preparing a prenuptial agreement.

The method of the present invention can further comprise: receiving user verification information from the user terminal; and inserting the user verification information to the draft for prenuptial agreement or the revised draft for prenuptial agreement. Here, the user verification information can comprise at least one of an electronic signature, user's facial image, iris recognition information, and finger print, and the user verification information can be for two or more users. An electronic signature can be a required condition to verify the preparer, and the user's facial image can be an optional condition.

The method of the present invention can further comprise: receiving a request for confirmation of prenuptial agreement from the user terminal; inserting a pre-stored certificate to the revised draft for prenuptial agreement corresponding to the request for confirmation of prenuptial agreement; and sending a confirmed prenuptial agreement added with the certificate to the user terminal.

The step of sending the confirmed prenuptial agreement to the user terminal can send the confirmed prenuptial agreement to a pre-designated e-mail address.

The step of sending information corresponding to a request for provision of information for married life, received from the user terminal, to the user terminal through a communication network can comprise: sending a plurality of pre-stored sample grounds for divorce to the user terminal; sending details corresponding to a selection of grounds for divorce, received from the user terminal, to the user terminal; sending a plurality of pre-stored sample grounds for happy marriage, if a request for grounds for happy marriage is received from the user terminal; and sending details corresponding to a selection of grounds for happy marriage, received from the user terminal, to the user terminal.

The step of sending information corresponding to a request for provision of information for married life, received from the user terminal, to the user terminal through a communication network can comprise: receiving selection information on any of the plurality of grounds for divorce and the plurality of grounds for happy marriage from the user terminal; creating an attachment to prenuptial agreement, using sample grounds for divorce and sample grounds for happy marriage corresponding to the selection information; and sending the created attachment to prenuptial agreement to the user terminal through a communication network.

The step of receiving a request for insertion of articles from the user terminal can comprise: receiving a request for provision of articles from the user terminal; sending one or more pre-stored articles to the user terminal through a communication terminal; and receiving a request for insertion of articles corresponding to selection information received from the user terminal.

The plurality of user terminals performing the method for preparing a prenuptial agreement based on the present invention can have a P2P (peer-to-peer) access.

Another preferred embodiment of the present invention provides a method of preparing a prenuptial agreement in a prenuptial agreement preparing system connected to one or more user terminals through a communication network, the method comprising: receiving a request for preparing a prenuptial agreement and provision of a proposed draft for prenuptial agreement from one or more user terminals; sending a pre-stored proposed draft for prenuptial agreement to the user terminal; sending information for married life corresponding to a request for provision of information for married life, if the request for provision of information for married life is received from the user terminal, to the user terminal through a communication network, wherein the information for married life is at least one of sample grounds for divorce and sample grounds for happy marriage; receiving a request for insertion of articles from the user terminal; creating a draft for prenuptial agreement by including articles corresponding to the request for insertion of articles to the proposed draft for prenuptial agreement; sending the draft for prenuptial agreement to the user terminal; receiving complementation or a request for revision on the draft for prenuptial agreement from the user terminal; creating a revised prenuptial agreement corresponding to the complementation or the revision request; and sending the revised prenuptial agreement to the user terminal, as well as a system, device and recorded medium enabling the execution of the method for preparing a prenuptial agreement.

### BRIEF DESCRIPTION OF THE DRAWINGS

These and other features, aspects, and advantages of the present invention will become better understood with regard to the following description, appended claims, and accompanying drawings where:

FIG. 1 shows an overall system for performing a method of preparing a prenuptial agreement using a communication network, based on a preferred embodiment of the present invention;

FIG. 2 shows a flowchart for creating a prenuptial agreement in a prenuptial agreement preparing system based on a preferred embodiment of the present invention;

FIG. 3 shows a flowchart detailing a process of providing information for married life, based on a preferred embodiment of the present invention;

FIG. 4 shows a flowchart detailing a process of producing a draft for a prenuptial agreement based on a preferred embodiment of the present invention;

FIG. 5 shows a flowchart detailing a process of producing a revised draft for a prenuptial agreement based on a preferred embodiment of the present invention;

FIG. 6 shows a flowchart for creating a prenuptial agreement in a user terminal, based on a preferred embodiment of the present invention;

FIGS. 7 through 16 show examples of screen display in a process of preparing a prenuptial agreement based on a preferred embodiment of the present invention;

FIG. 17 shows a flowchart for creating a prenuptial agreement in a prenuptial agreement preparing system, based on another preferred embodiment of the present invention;

FIGS. 18 through 20 show examples of screen display in a process of preparing an attachment to a prenuptial agreement based on another preferred embodiment of the present invention;

FIG. 21 shows a flowchart for creating an asset division agreement in a prenuptial agreement preparing system based on yet another preferred embodiment of the present invention;

FIGS. 22 through 24 show examples of screen display in a process of creating an asset division agreement, based on yet another preferred embodiment of the present invention;

FIG. 25 shows a flowchart for preparing a prenuptial agreement in a prenuptial agreement preparing system based on yet another preferred embodiment of the present invention; and

FIG. 26 shows an example of screen display in a process of preparing a prenuptial agreement based on yet another preferred embodiment of the present invention.

### DETAILED DESCRIPTION OF THE PREFERRED EMBODIMENT

Preferred embodiments of the present invention will be described hereinafter with reference to accompanying drawings. Although the description herein will focus on a bride and groom, who are planning a marriage, as a prospect for preparing a prenuptial agreement based on the subject invention, the prenuptial agreement based on the subject invention can be equally applied to a husband and wife, who are currently married, and a man and woman who have a relationship by contract, are in a de facto marriage, living together, want to get married again, or in a relationship, provided that the title can be modified from prenuptial agreement to nuptial agreement, cohabitation agreement, relationship agreement, and many other variations.

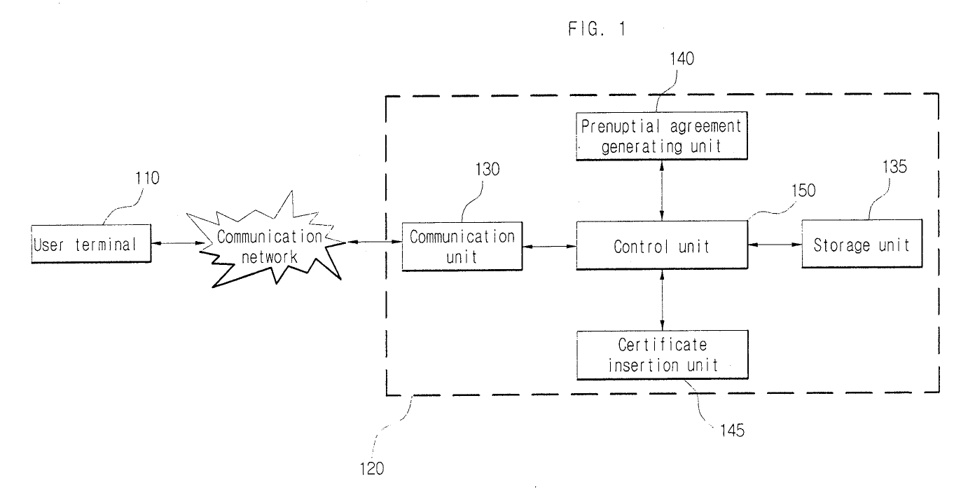

FIG. 1 is a diagram showing an overall system for performing a method of preparing a prenuptial agreement using a communication network, based on a preferred embodiment of the present invention

Referring to FIG. 1, a prenuptial agreement preparing system 120 comprises a communication unit 130, a storage unit 135, a prenuptial agreement generating unit 140, a certificate insertion unit 145, and a control unit 150, and can be part of a system of a law firm that certifies a prenuptial agreement prepared by the marrying parties.

The communication unit 130 performs functions of receiving a request to prepare a prenuptial agreement through a communication network from a user terminal 110 of the marrying parties and sending a prepared prenuptial agreement to the user terminal 110. The user terminal 110 can be any device that is capable of accessing the prenuptial agreement preparing system 120 through a communication network and transmitting selections for preparing a prenuptial agreement, and a computer, a mobile communication terminal or a PDA (personal digital assistant), for example, can qualify as a user terminal.

The storage unit 135 stores the membership information of marrying parties (e.g., name, resident registration number, etc.) as well as grounds for divorce, grounds for happy marriage, proposed drafts of a prenuptial agreement, insertable texts, and a completed prenuptial agreement, for the marrying parties to prepare a prenuptial agreement.

The prenuptial agreement generating unit 140 generates a prenuptial agreement using the selections the marrying parties.

The certificate insertion unit 145 inserts a certificate to a prenuptial agreement created by the selections of the marrying parties.

The control unit 150 controls the communication unit 130, storage unit 135, prenuptial agreement generating unit 140, and certificate insertion unit 145 such that the marrying parties can prepare a prenuptial agreement using the prenuptial agreement preparing system 120.

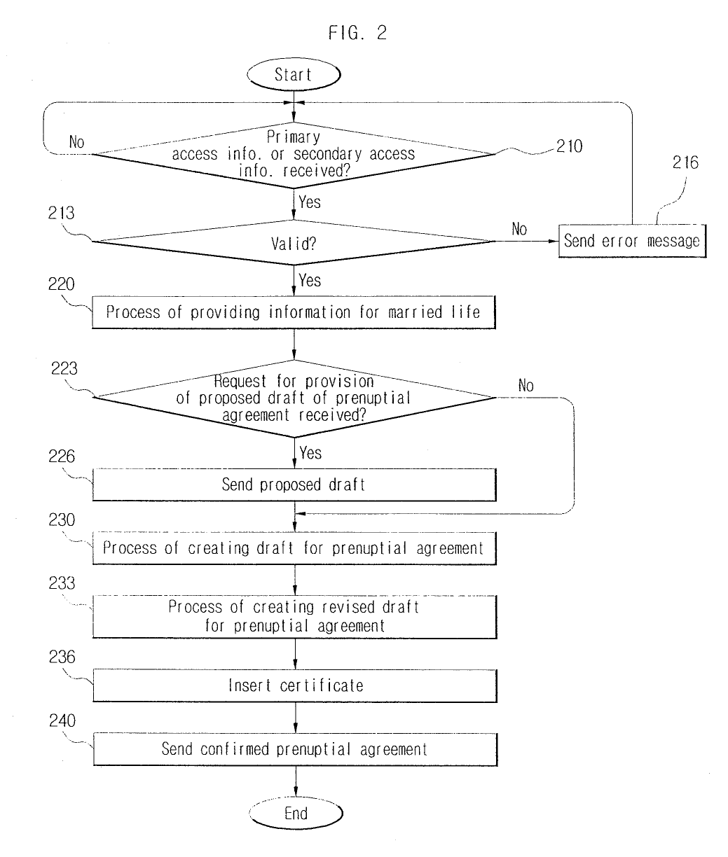

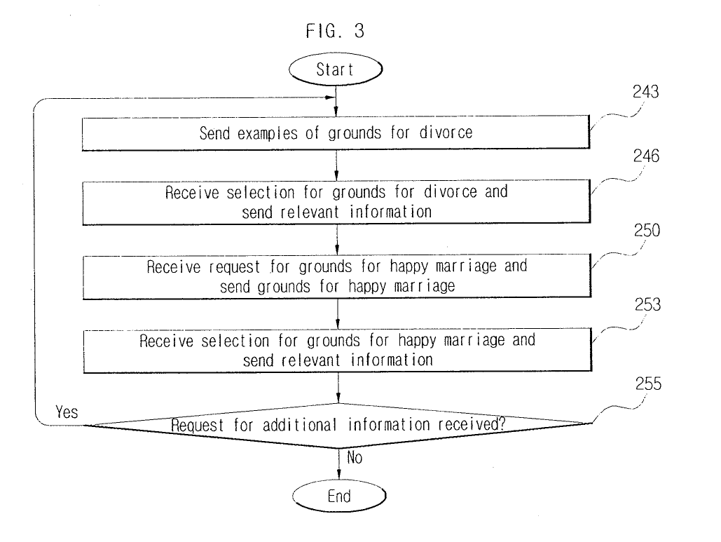

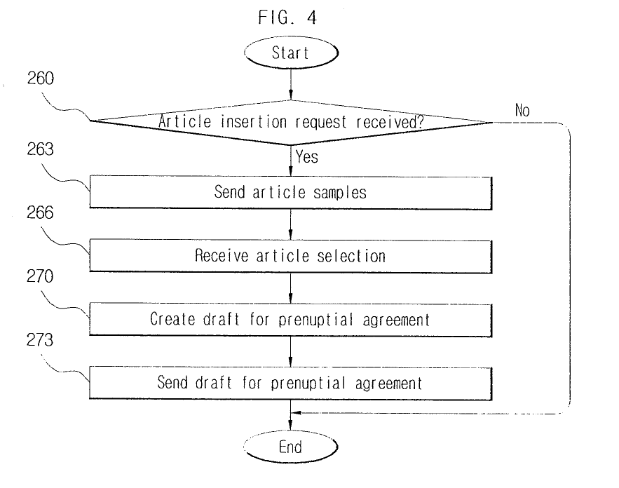

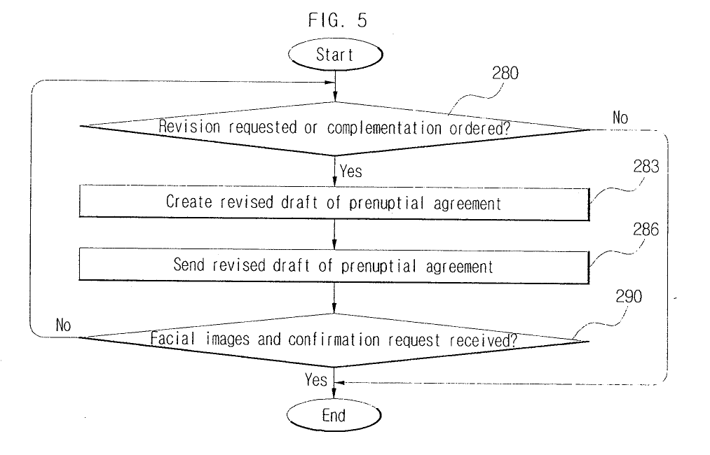

FIG. 2 is a flowchart for creating a prenuptial agreement in a prenuptial agreement preparing system based on a preferred embodiment of the present invention; FIG. 3 is a flowchart detailing a process of providing information for married life, based on a preferred embodiment of the present invention; FIG. 4 is a flowchart detailing a process of producing a draft for a prenuptial agreement based on a preferred embodiment of the present invention; and FIG. 5 is a flowchart detailing a process of producing a revised draft for a prenuptial agreement based on a preferred embodiment of the present invention.

Referring to FIG. 2, the prenuptial agreement preparing system 120 determines, in step 210, whether access information (e.g., ID and password) is received from the user terminal 110 of the marrying parties through a communication network. The access information can comprise access information of the groom (i.e., primary access information) and access information of the bride (i.e., secondary access information), and it is preferable that the bride and groom have signed up for a membership already for use of the prenuptial agreement preparing system 120.

In case access information is received, the prenuptial agreement preparing system 120 determines, in step 213, if the access information received in step 210 is valid. In other words, the prenuptial agreement preparing system 120 is performing a primary authentication of the bride and groom in step 213. In case the access information is invalid (e.g., some or all of the access information is invalid), step 216 is performed to send an error message (e.g., “The password of the groom is incorrect; please enter again.”) to the user terminal 110, and step 210 is repeated. In case the access information received in step 210 is correct, however, step 220 is performed.

In step 220, the prenuptial agreement preparing system 120 provides information for married life (e.g., grounds for divorce and grounds for happy marriage) corresponding to the selection received from the user terminal 110.

Referring to FIG. 3, which details a process of providing information for married life, the prenuptial agreement preparing system 120 extracts, in step 243, one or more pre-stored grounds for divorce (e.g., “A spouse has been unfaithful”) and sends to the user terminal 110 through a communication network.

In step 246, the prenuptial agreement preparing system 120 receives a section for a ground for divorce from the user terminal 110, and sends the pre-stored relevant information (e.g., details and preventive measures) corresponding to the selection.

In step 250, the prenuptial agreement preparing system 120 receives a request for information on grounds for happy marriage, extracts one or more pre-stored grounds for happy marriage (e.g., “Trying to be trustworthy”) and sends to user terminal 110 through a communication network.

In step 253, the prenuptial agreement preparing system 120 receives a selection for a ground for happy marriage from the user terminal 110, extracts and sends the pre-stored relevant information (e.g., details) corresponding to the selection to the user terminal 110.

Although steps 243 through 253 described above can be sequential, these steps can be process inconsecutively according to a user's selection.

In step 255, the prenuptial agreement preparing system 120 determines if a request for additional information on grounds for divorce or happy marriage is received from the user terminal 110. If additional information is requested, step 243 is performed; otherwise, the process of providing information for married life is terminated.

Referring back to FIG. 2, the prenuptial agreement preparing system 120 determines, in step 223, if a request for provision of a proposed draft of a prenuptial agreement is received from the user terminal 110. If a proposed draft is requested, a pre-designated proposed draft of a prenuptial agreement containing marrying party information (e.g., name, resident registration number, etc.) is sent, in step 226, to the user terminal 110 through a communication network. If a proposed draft is not requested, however, step 230 is performed.

In step 230, the prenuptial agreement preparing system 120 creates a draft for a prenuptial agreement using the selection and proposed draft received from the user terminal 110 of the marrying parties.

Referring to FIG. 4, which details the process of creating a draft for a prenuptial agreement, the prenuptial agreement preparing system 120 determines, in step 260, if insertion of text contained in the prenuptial agreement is requested from the user terminal 110. If insertion of text is requested, one or more pre-stored text samples are extracted, in step 263, and sent to the user terminal through a communication network. In step 266, the selection for text is received from the user terminal 110; in step 270, the draft for a prenuptial agreement inserted with the selected text is created; and in step 273, the created draft is sent to the user terminal 110 through a communication terminal. Steps 260 through 273, of course, can be repeated several times if the marrying parties select texts to be inserted several times.

Referring to FIG. 2 again, the prenuptial agreement preparing system 120 creates a revised draft of the prenuptial agreement, in step 233, if revision of the draft is requested from the user terminal or ordered from an administrator.

Referring to FIG. 5, which details the process of creating revised draft of the prenuptial agreement, the prenuptial agreement preparing system 120 determines, in step 280, if revision on the draft is requested from the user terminal 110 or complementation (e.g., revision or addition) on the draft is ordered from an administrator (e.g., attorney) of the prenuptial agreement preparing system 120. Since steps up to 230 were carried out by the marrying parties only, legal flaws are quite possible, and a process of being complemented by the system administrator may be thus necessary.

If there are matters to be revised or complemented, the prenuptial agreement preparing system 120 creates a revised draft of the prenuptial agreement in step 283 using the details of revision or complementation, and sends the revised draft to the user terminal 110 through a communication network in step 286.

Referring back to step 280, if there is no request for revision or complementation, the process of creating a revised draft for the prenuptial agreement is terminated (that is, proceeds to step 236).

Later in step 290, the prenuptial agreement preparing system 120 determines if request for facial images of the marrying parties and confirmation of the prenuptial agreement is received from the user terminal 110. If the facial images and confirmation are not requested, step 280 is performed. If the facial images and confirmation are requested, however, step 236 is performed, and the process of creating a revised draft of the prenuptial agreement is terminated. Of course, the user authentication information (i.e., information for verifying or authenticating the user) required to be inserted in a prenuptial agreement is an electronic signature, and the facial images can be only supplementary information. However, the description herein will assume that insertion of the facial images of the marrying parties is required for verifying or authenticating the parties, for the convenience of understanding. It is also possible to have both the facial images and the electronic signature included. The facial images of the marrying parties are inserted to ascertain the authenticity and strengthen the reliability of the prenuptial agreement. The facial images can be photographed real-time by a web camera connected to the user terminal 110 and sent, or can be images that have been stored in the user terminal 110.

Referring back to FIG. 2, the prenuptial agreement preparing system 120 add (or insert) a pre-designated certificate to the confirmed prenuptial agreement in step 236. Later in step 240, the prenuptial agreement preparing system 120 sends the confirmed prenuptial agreement to the user terminal 110 through a communication terminal. In step 240, the prenuptial agreement can be sent to the e-mail address of each marrying party. Moreover, the prenuptial agreement can be also stored in the prenuptial agreement preparing system 120 for later revision even after the commencement of the marriage.

So far, the method for preparing a prenuptial agreement involves a primary draft of the prenuptial agreement, which is inserted with or adopted details requested by both marrying parties, and a secondary revised draft of the prenuptial agreement, which includes revision requested by both parties or complementation commanded by a law firm, followed by a certificate by the law firm after the revised draft is confirmed. In some cases, however, a prenuptial agreement can be prepared by an agreement of both marrying parties only. In such cases, step 233 of adding complementation by a law firm or step 236 of attaching a certificate can be skipped.

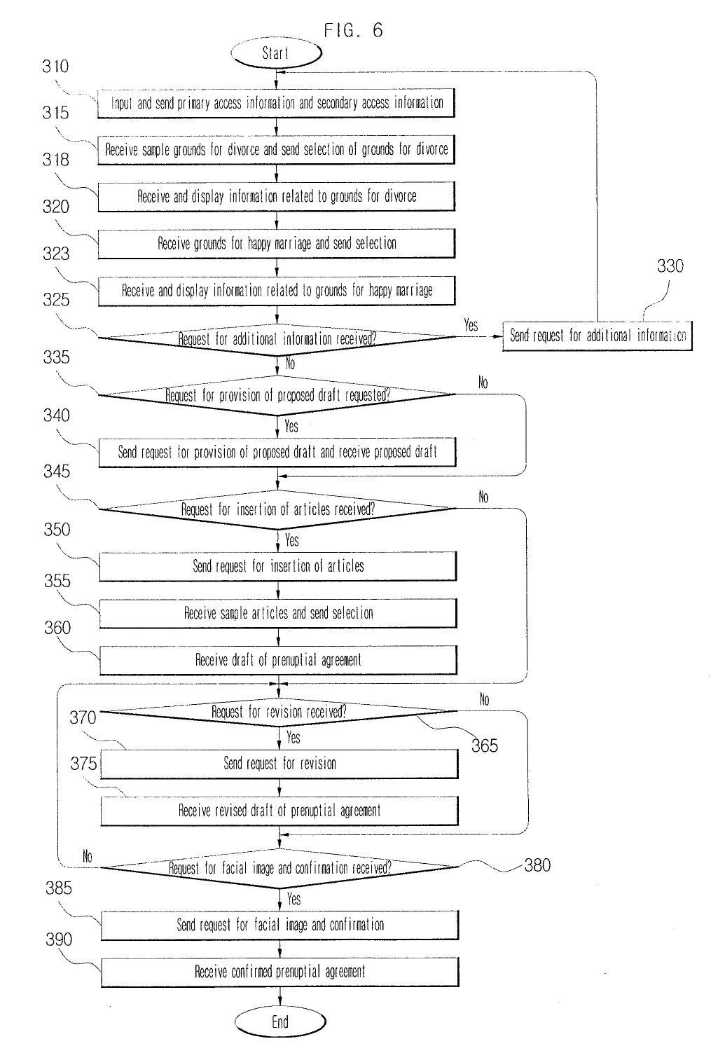

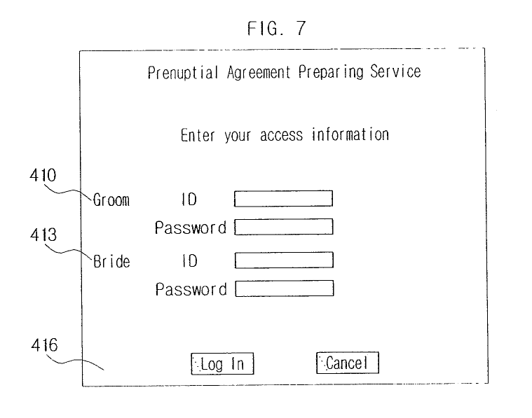

FIG. 6 is a flowchart for creating a prenuptial agreement in a user terminal, based on a preferred embodiment of the present invention, and FIGS. 7 through 16 are examples of screen display in a process of preparing a prenuptial agreement based on a preferred embodiment of the present invention

FIG. 6 illustrates a process of creating a prenuptial agreement by the marrying parties after accessing the prenuptial agreement preparing system 120 (i.e., a website providing a prenuptial agreement preparing service) using the user terminal 110. In describing a method of preparing a prenuptial agreement with reference to FIG. 6, the examples of screen display illustrated in FIGS. 7 through 16 will be described together for the convenience of understanding.

Referring to FIG. 6, the user terminal 110 receives the access information from each marrying party in step 310 and sends to the prenuptial agreement preparing system 120 through a communication network. Although it is true that the same service can be provided even if only one party is a member of the prenuptial agreement preparing system 120, the description herein will assume the case that both parties input the access information of each party. Moreover, despite the fact that both marrying parties can use a single user terminal 110 to prepare a prenuptial agreement together, each marrying party can use a separate user terminal 110 to access the same website and prepare a prenuptial agreement. An example of screen display for the case of both marrying parties inputting access information using one user terminal 110 is shown in FIG. 7. The access information input screen illustrated in FIG. 7 comprises an access information input area for the groom 410, an access information input area for the bride 413, and function buttons area 416. A view button for “grounds for happy marriage” can be additionally included. Inputting access information (i.e., ID and password) in the access information input area for the bride 410 and access information input area for the bride and clicking the log in button sends the access information to the prenuptial agreement preparing system 120 through a communication network.

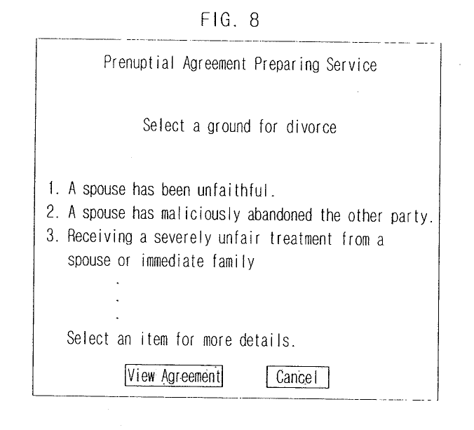

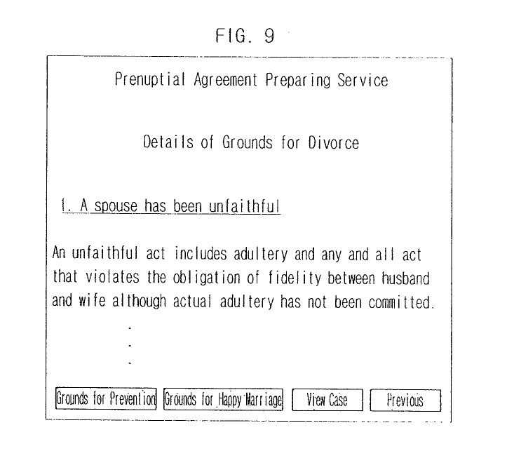

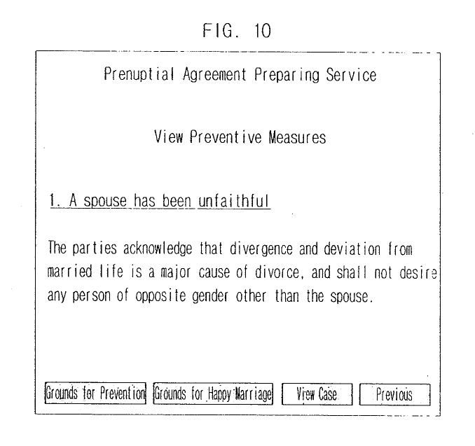

Referring to FIG. 6 again, the user terminal 110 receives one or more samples of grounds for divorce from the prenuptial agreement preparing system 120 and displays the received sample grounds for divorce on the display unit before sending a selection of grounds for divorce inputted by a marrying party to the prenuptial agreement preparing system 120 through a communication network. In step 318, information related to grounds for divorce, such as details and preventive measures, is received from the prenuptial agreement preparing system 120 and is displayed on the display unit. An example of screen display of sample grounds for divorce, received from the prenuptial agreement preparing system 120, is shown in FIG. 8, and an example of detailed description of grounds for divorce, displayed on the display unit, is illustrated in FIG. 9, while an example of preventive measures displayed on the display unit is shown in FIG. 10.

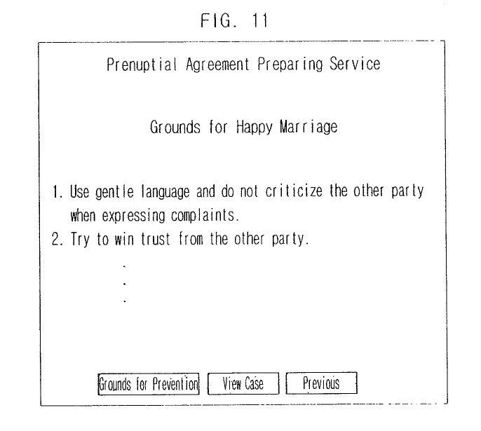

Referring to FIG. 8, the display screen of sample grounds for divorce comprises one or more sample grounds for divorce and “View Agreement” and “Cancel” buttons. The display screen of details, shown in FIG. 9, displayed when any of the marrying parties clicks a sample ground for divorce (e.g., “1. A spouse has been unfaithful”) comprises detailed description, a “Grounds for Prevention” button, a “Grounds for Happy Marriage” button, a “View Case” button, and a “Previous” button. The display screen of preventive measures, shown in FIG. 10, displayed when any of the marrying parties clicks the “Grounds for Prevention” button comprises detailed description of preventive measures, a “Grounds for Divorce” button, a “Grounds for Happy Marriage” button, a “View Case” button, and a “Previous” button. In case the “Grounds for Divorce” button of FIG. 10 is clicked, the display unit of the user terminal 110 displays the screen of FIG. 8 again. The “Grounds for Happy Marriage” button is for moving to a screen to view grounds for happy marriage (refer to FIG. 11), and the “View Case” button is for listing court cases related to the pertinent ground for divorce, while the “Previous” button is for moving back to the previous screen.

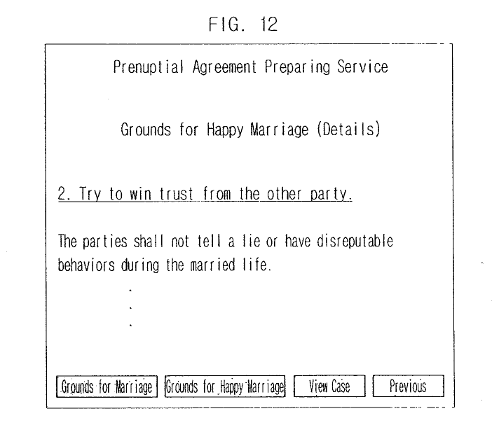

Referring back to FIG. 6, the user terminal 110 received one or more grounds for happy marriage from the prenuptial agreement preparing system 120, in step 320, and displays the received grounds for happy marriage on the display unit before sending the selection for any ground for happy marriage received from a marrying party to the prenuptial agreement preparing system 120 through a communication network. As described above, the grounds for happy marriage can be displayed on the display unit of the user terminal 110 in case the “Grounds for Happy Marriage” button shown in FIG. 8, 9, or 10 is clicked. Later, the user terminal 110 receives, in step 323, related information (e.g., details) corresponding to the selection received through step 320 and displays on the display unit. An example of grounds for happy marriage, received from the prenuptial agreement preparing system 120, displayed on the display unit is shown in FIG. 11, and the display screen of details when a ground for happy marriage is clicked is shown in FIG. 12. In case the “Grounds for Marriage” button, shown in FIG. 12, is clicked, the screen shown in FIG. 11 is displayed again on the display unit of the user terminal 110.

Referring back to FIG. 6, the user terminal 110 determines in step 325 if a request for additional information is received from the marrying parties. A request for additional information is for listing other grounds for divorce or happy marriage. If additional information is requested, step 330 is performed to send the request for additional information to the prenuptial agreement preparing system 120 through a communication network, and step 315 is repeated. If no additional information is requested, however, step 335 is performed.

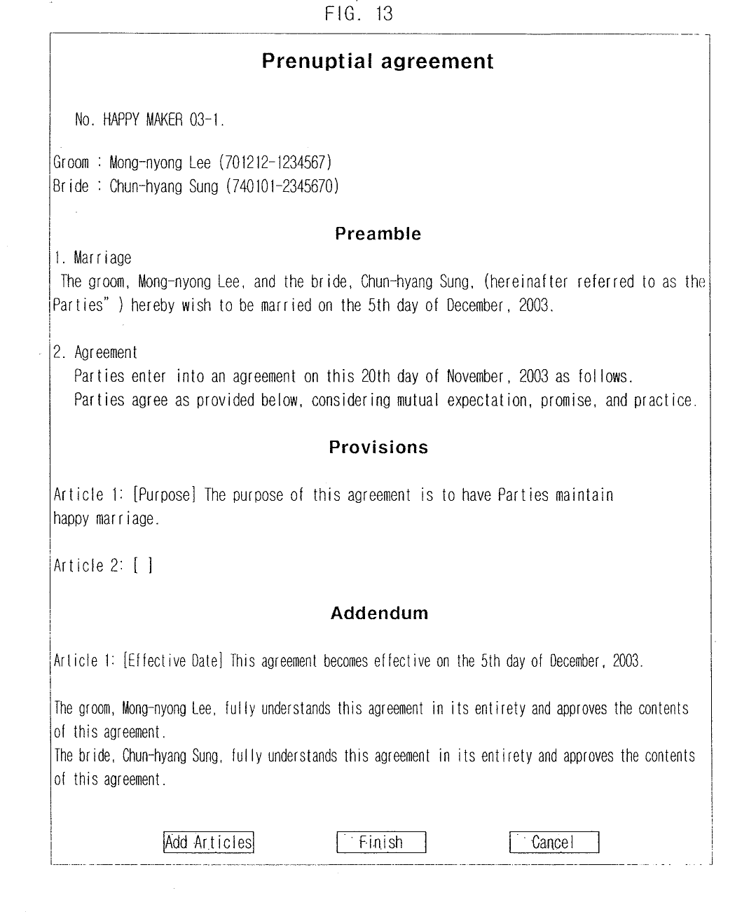

In step 335, the user terminal 110 determines if a request for a proposed draft of the prenuptial agreement is received from a user. The marrying parties can input a request for provision of a proposed draft of the prenuptial agreement by selecting the “View Agreement” button illustrated in FIG. 8. The “View Agreement” button can be included in all of Figs. between 8 and 12, and can be substituted by a “View Proposed Draft” button to distinguish from viewing the draft or revised draft. When the request for a proposed draft is received, the user terminal 110 sends, in step 340, the request to the prenuptial agreement preparing system 120 through a communication network, and receives the proposed draft of the prenuptial agreement from the prenuptial agreement preparing system 120 and displays on the display unit. A proposed draft of the prenuptial agreement is illustrated in FIG. 13. A proposed draft of the prenuptial agreement can comprise personal information (e.g., name and resident registration number), preamble, and addendum. The personal information can be created or inserted using the user information collected in step 310. As illustrated in FIG. 13, the “Provisions” section can have the basic article (i.e., Article 1) only as a complete form and keep the remaining articles blank. If provision of a proposed draft is not requested, however, step 345 is performed.

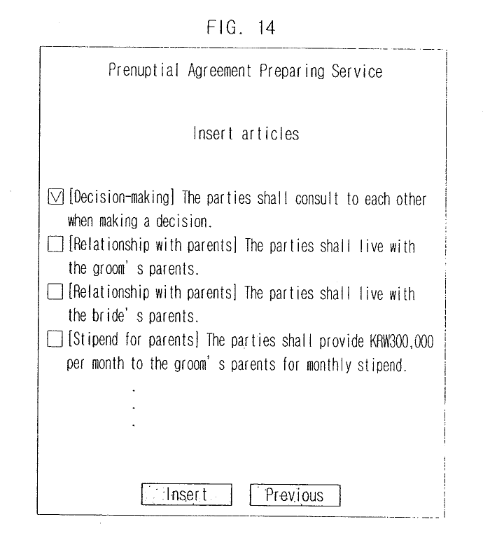

In step 345, the user terminal 110 determines if insertion of articles is requested by the marrying parties. If insertion of articles is requested, the user terminal 110 sends the request for insertion of articles, in step 350, to the prenuptial agreement preparing system 120 through a communication network. Then in step 355, samples of articles are received from the prenuptial agreement preparing system 120 and displayed on the display unit, and the selection received from the marrying parties is sent to the prenuptial agreement preparing system 120 through a communication network. For example, the marrying parties can click the “Add Articles” button in a proposed draft, illustrated in FIG. 13, to have an article selection screen display on the display unit of the user terminal 110. Referring to FIG. 14, the article selection screen comprises the article display area and the function buttons area. The article display area is for displaying a plurality of articles (e.g., [Decision-making] The parties shall consult to each other when making a decision) that can be inserted in the prenuptial agreement. When the marrying party selects an article and clicks the “Insert” button located in the lower part, the selected article is inserted in the prenuptial agreement.

In step 360, the user terminal 110 receives a draft for the prenuptial agreement from the prenuptial agreement preparing system 120 and displays the received draft on the display unit.

In step 365, the user terminal determines if revision on the draft of the prenuptial agreement is requested from the marrying parties. The revision request is for revision of text or addition of articles in the draft of the prenuptial agreement. If a request for revision is received, step 370 sends the revision request on the part designated by the marrying parties to the prenuptial agreement preparing system 120 through a communication network. In step 375, the user terminal 110 receives a revised draft of the prenuptial agreement reflected by the revision request from the prenuptial agreement preparing system 120. If revision is not requested, however, step 380 is performed.

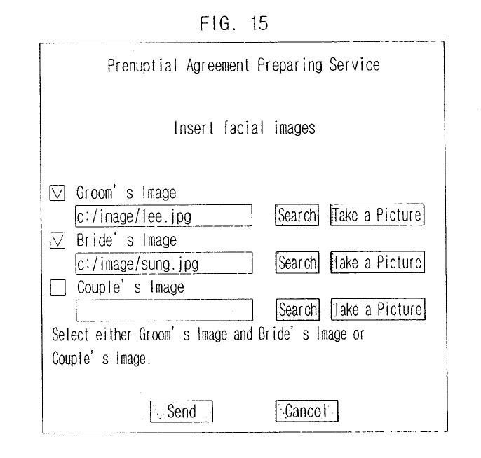

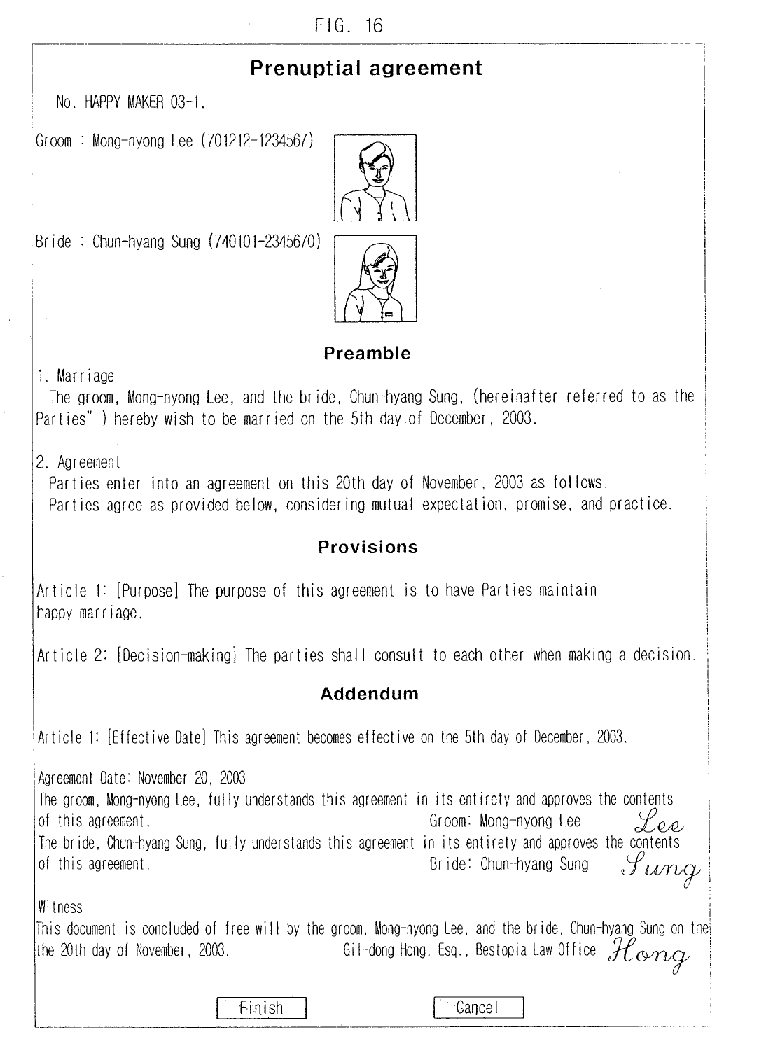

In step 380, the user terminal 110 determines if a request for a facial image and confirmation of the prenuptial agreement is received from the marrying parties. Of course, receiving of an electronic signature can be additionally determined if insertion of a certificate or an electronic signature in the prenuptial agreement is a required condition. If a request for a facial image and confirmation of the prenuptial agreement is received, step 385 sends the received request for a facial image and confirmation to the prenuptial agreement preparing system 120 through a communication network. Then in step 390, the user terminal 110 receives the prenuptial agreement from the prenuptial agreement preparing system 120 and display on the display unit. FIG. 15 illustrates a screen for inserting facial images. A screen for inserting facial images comprises the facial image selection area and the function buttons area. The facial image selection area comprises the groom's image selection area, the bride's image selection area, and the couple's image selection area. Each selection area can further comprise a “Search” button and a “Take a Picture” button. The “Search” button is for designating a facial image pre-stored in the storage unit of the user terminal 110, and the “Take a Picture” button is for taking a picture of a real-time image, using a web camera. After photographing or designating facial images, clicking the “Send” button completes the inputting of the facial image. An example of the created prenuptial agreement, in which the facial images (and/or electronic signatures) and confirmation of the agreement are received, is illustrated in FIG. 16. Referring to FIG. 16, facial images (and/or electronic signatures) of the marrying parties, articles selected by the marrying parties, and a certificate by a law firm are added to the proposed draft of FIG. 13. When an electronic signal is included in the prenuptial agreement, the appearance of the electronic signature is not restricted to a certain form and can take a wide variety of forms. For example, the electronic signatures in FIG. 16 assume a form of signature, but the signature can be a form of seal or print (fingerprint, for example). The marrying parties can complete the process of preparing and confirming the prenuptial agreement by clicking the “Finish” button located in the lower part of the screen. Once the “Finish” button is selected, the prenuptial agreement preparing system 120 can send the confirmed prenuptial agreement to the e-mail address of each marrying party.

So far, with reference to FIG. 2 through 16, the description focused on eliminating any controversy of the authenticity of the prenuptial agreement by inserting the facial images (and/or electronic signatures) of the marrying parties in the prenuptial agreement. Other means for eliminating controversy of the authenticity can further comprise a method of including physical information unique to the marrying party. The physical information can include a fingerprint, palm lines, and iris recognition. The electronic signature applied in this invention refers to electronic information that is added or logically combined in an electronic document for use of verifying the signatory and indicating that the signatory has signed the electronic document. Since the means for identifying the signatory and the authenticity of the signatory is currently applied in electronic contract services, Internet civil services, and electronic receipts, detailed description will not be provided herein.

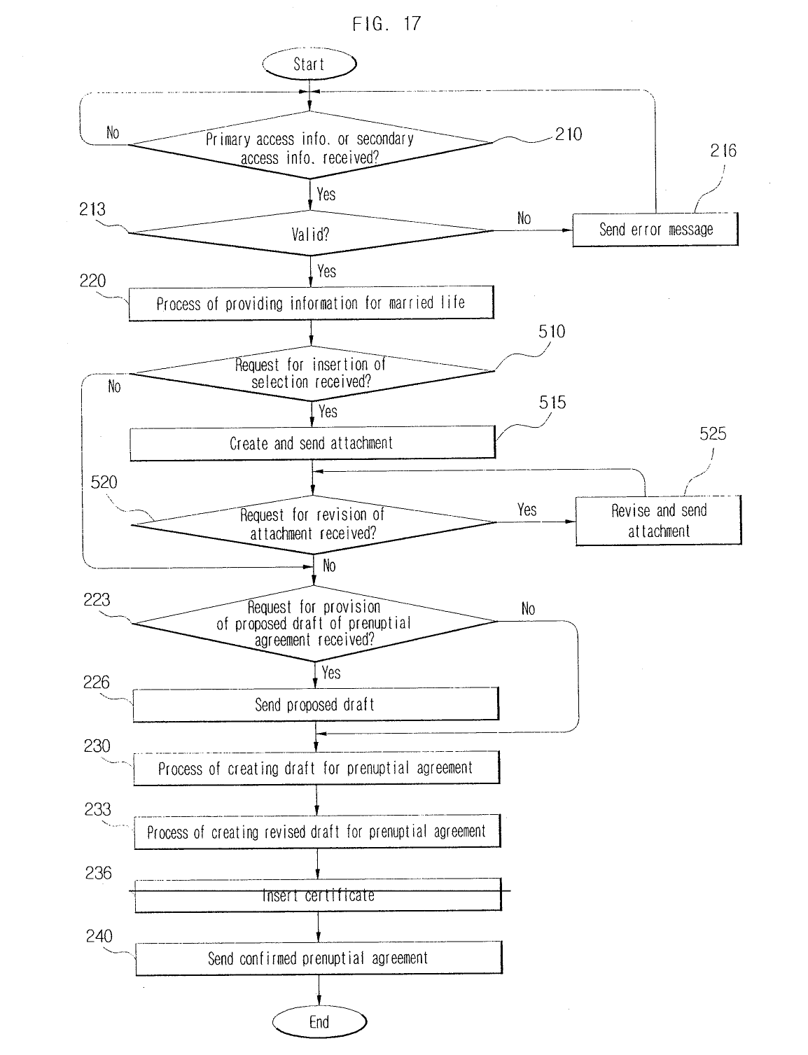

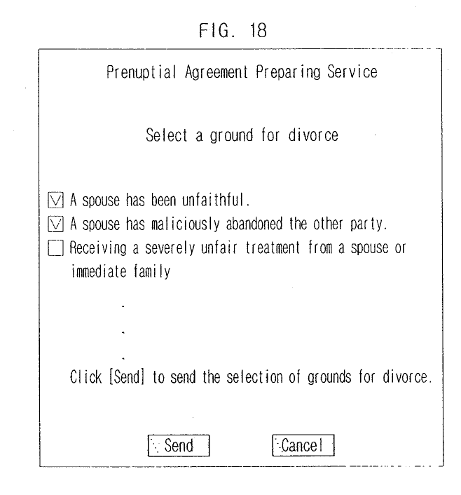

FIG. 17 is a flowchart for creating a prenuptial agreement in a prenuptial agreement preparing system, based on another preferred embodiment of the present invention, and FIGS. 18 through 20 are examples of screen display in a process of preparing an attachment to a prenuptial agreement based on another preferred embodiment of the present invention.

In describing FIG. 17, any description that is identical in FIG. 2 will be skipped.

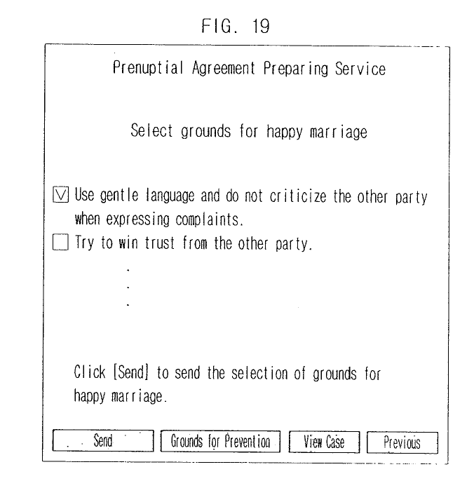

Referring to FIG. 17, the prenuptial agreement preparing system 120 determines, in step 510, if a request for inclusion of a selection of information for married life is received from the user terminal 110. A marrying party can select a ground for divorce on the screen showing sample grounds for divorce, shown in FIG. 18, or a ground for happy marriage on the screen showing sample grounds for happy marriage, illustrated in FIG. 19. Furthermore, a marrying party can send the selection to the prenuptial agreement preparing system 120 by clicking the “Send” button displayed in the lower part of the screen.

In step 515, the prenuptial agreement preparing system 120 creates an attachment to prenuptial agreement, using the selection included in the received request for insertion of a selection, and sends the created attachment to the prenuptial agreement preparing system 120 through a communication network.

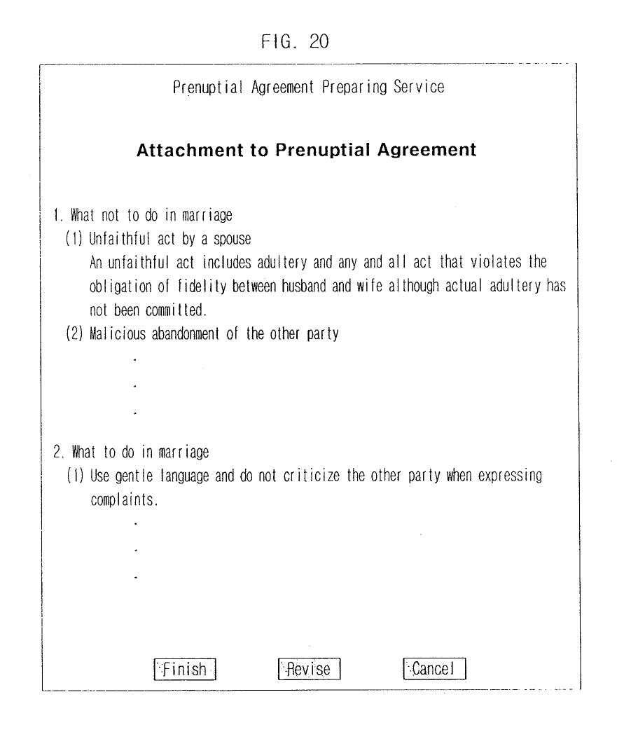

Later, the prenuptial agreement preparing system 120 determines, in step 520, if a request for revision (e.g., addition of a selection, correction of a text, deletion of an article, etc.) of the attachment is received from the user terminal 110. If revision is requested, step 525 is performed to revise the attachment according to the received revision request and send the revised attachment to the user terminal 110 before proceeding to step 520. If no revision request is received, however, step 223 is performed. Referring to the attachment to prenuptial agreement illustrated in FIG. 20, the attachment comprises grounds for divorce selected by the marrying party (i.e., what not to do in the marriage), grounds for happy marriage selected by the marrying party (i.e., what to do in the marriage), and function buttons.

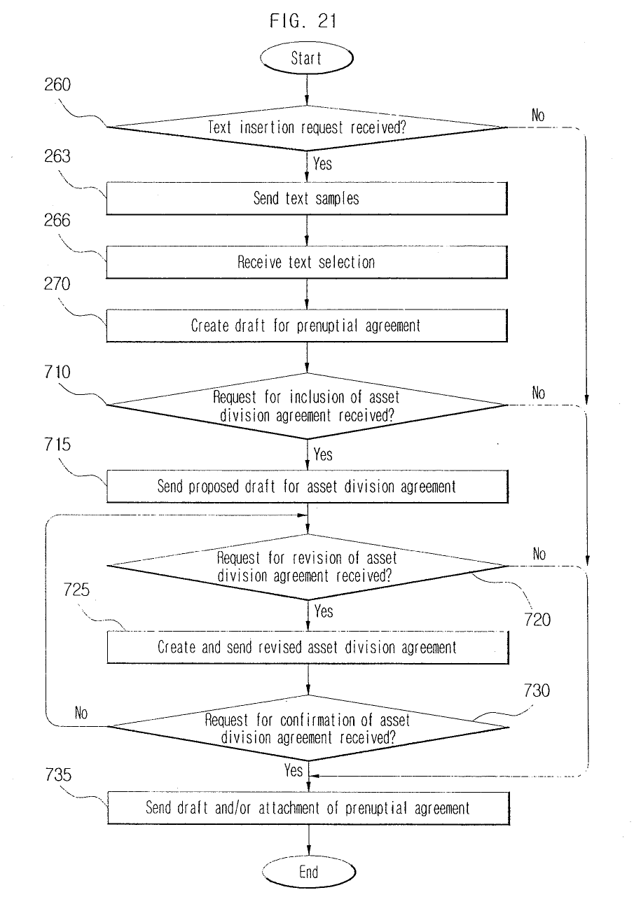

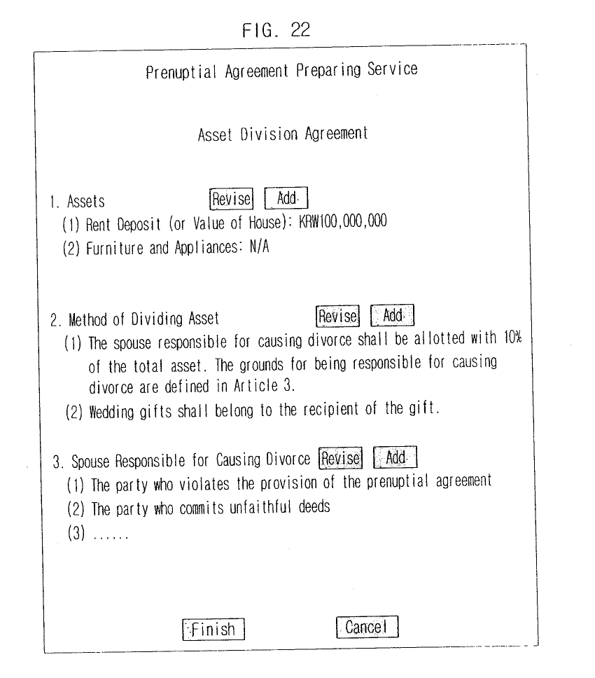

FIG. 21 is a flowchart for creating an asset division agreement in a prenuptial agreement preparing system based on yet another preferred embodiment of the present invention, and FIGS. 22 through 24 are examples of screen display in a process of creating an asset division agreement, based on yet another preferred embodiment of the present invention.

Although it is apparent that creating an asset division agreement, illustrated in FIG. 21, can be a separate process from the process of creating a prenuptial agreement, described with reference to FIG. 4, the description herein will be based on the case of the process of creating an asset division agreement being part of the process of creating a prenuptial agreement. Moreover, any description that is redundant with reference to FIG. 4 will be omitted.

Referring to FIG. 21, the prenuptial agreement preparing system 120 determines, in step 710, if a request for inclusion of an asset division agreement is received from the user terminal 110. The marrying party can input a request for inclusion of an asset division agreement, using a menu button or a function button of a web page corresponding to the prenuptial agreement preparing system 120. In case a request for inclusion of an asset division agreement is received, the prenuptial agreement preparing system 120 sends, in step 715, a proposed draft for asset division agreement to the user terminal 110 through a communication network. FIG. 22 illustrates an example of proposed draft for asset division agreement, displayed on the display unit of the user terminal 110. Referring to FIG. 22, the proposed draft for asset division agreement comprises basic information (e.g., items to be agreed in asset division, individual items) and function buttons.

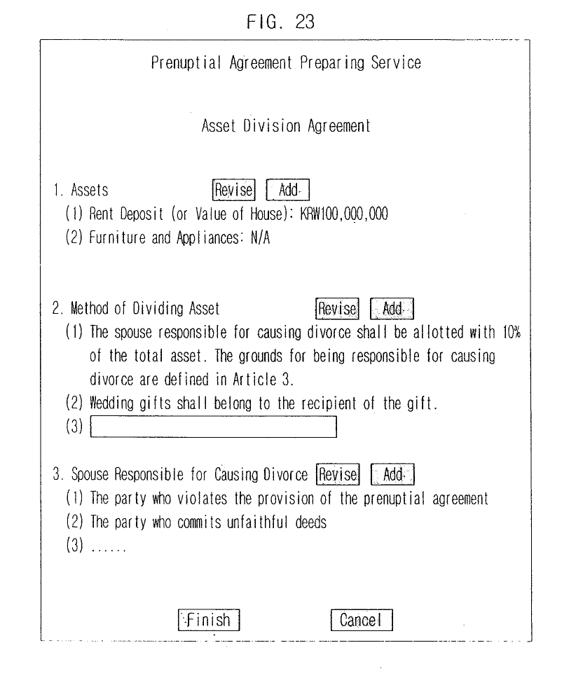

In step 720, the prenuptial agreement preparing system 120 determines if a request for revision of asset division agreement is received from the user terminal 110. The marrying party can revise any item of the asset division agreement by selecting the “Revise” button or “Add” button, shown in FIG. 22, corresponding to the asset division item. FIG. 23 is an example of screen display when the marrying party selects the “Add” button corresponding to “2. Method of Dividing Asset.”

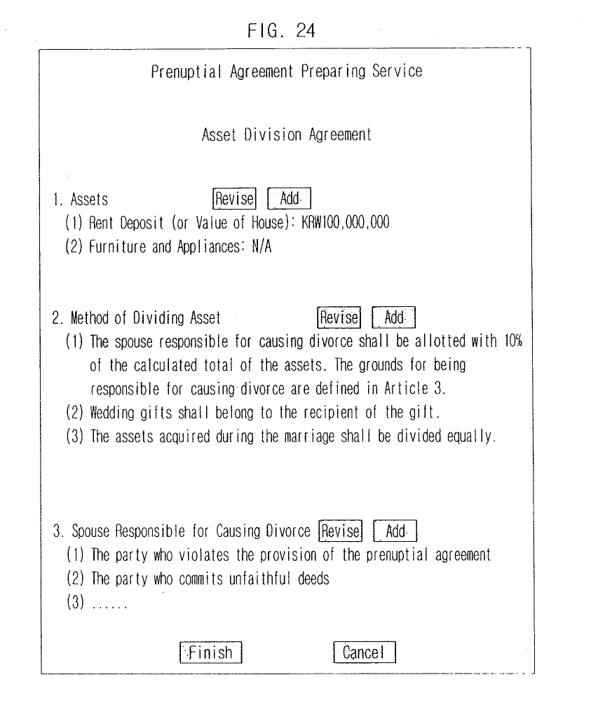

When a request for revision of asset division agreement is received, the prenuptial agreement preparing system 120 creates, in step 725, a revised draft for asset division agreement corresponding to the request, and sends the revised draft to the user terminal 110. An example of the revised draft for asset division agreement received and displayed on the display unit is shown in FIG. 24. The revised draft illustrated in FIG. 24 shows a case of revising the item (1) and adding the item (3) of “2. Method of Dividing Asset.” Of course, it should be apparent that the rate of division within the asset division method can be revised at the discretion of the marrying parties.

Later in step 730, the prenuptial agreement preparing system 120 determines if a request for confirmation of asset division agreement is received from the user terminal 110. If a request for confirmation of asset division agreement is received, the prenuptial agreement preparing system 120 sends the draft and/or attachment of prenuptial agreement to the user terminal 110 through a communication network. The asset division agreement created in steps 710 through 730 can be part of the prenuptial agreement or stand alone as a separate agreement. If no request for confirmation of asset division agreement is received, however, step 720 is repeated.

As described above, an asset division agreement, created in steps 710 through 730 and certified by a law firm, can allow a rational division of assets by the parties in case of divorce. Of course, creating a child custody agreement, which is similar to an asset division agreement, when or after making the initial agreement, can solve the issue of child custody, which is the most difficult stumbling block to overcome during a divorce process.

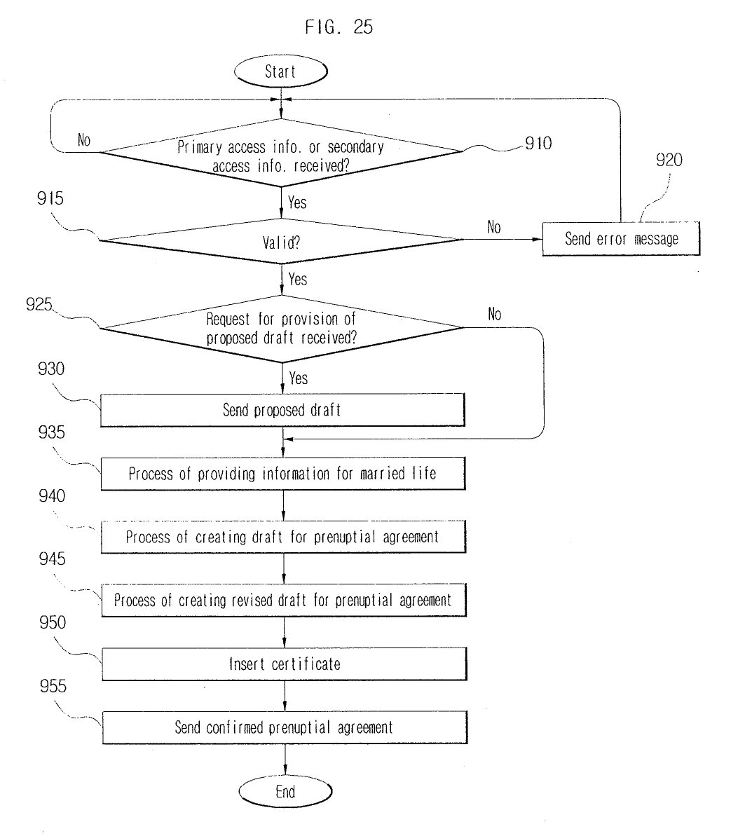

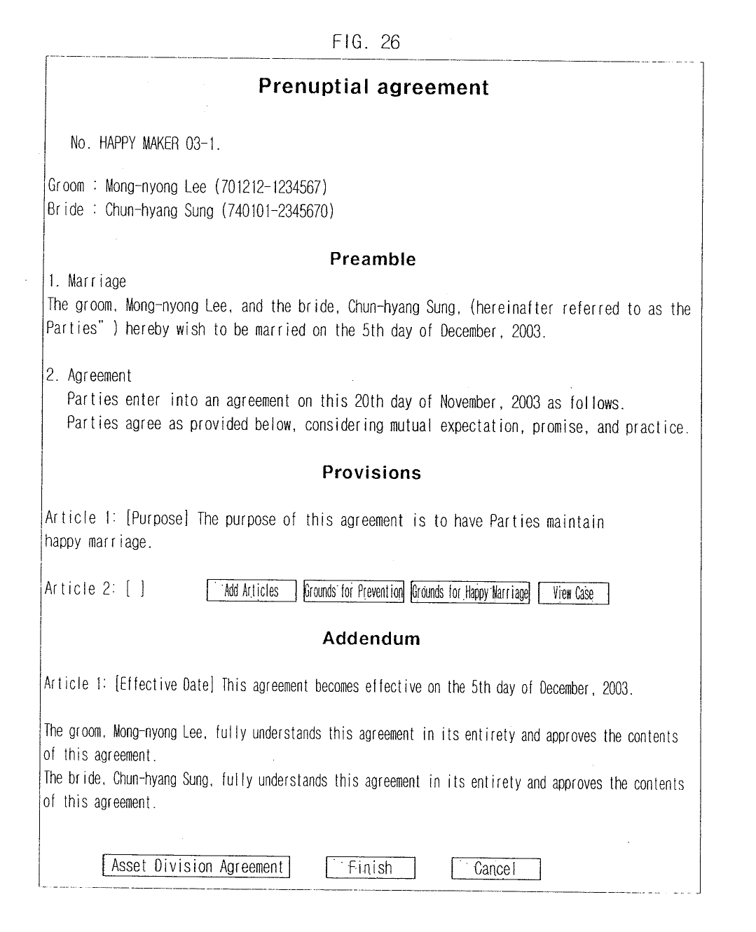

FIG. 25 is a flowchart for preparing a prenuptial agreement in a prenuptial agreement preparing system based on yet another preferred embodiment of the present invention, and FIG. 26 is an example of screen display in a process of preparing a prenuptial agreement based on yet another preferred embodiment of the present invention.

Description of any step identical to that of FIG. 2 will be simplified herein.

Referring to FIG. 25, the prenuptial agreement preparing system 120, in steps 910 through 920, checks for the authenticity of the received access information of the marrying parties. If the access information is valid, the prenuptial agreement preparing system 120 determines, in step 925, if a request for provision of a proposed draft of prenuptial agreement is received from the user terminal 110. If provision of the proposed draft is requested, step 930 sends the pre-prepared proposed draft to the user terminal 110 through a communication network. An example of the proposed draft displayed on the display unit of the user terminal 110 is illustrated in FIG. 26. Referring to the proposed draft of prenuptial agreement shown in FIG. 26, a proposed draft can comprise personal information (e.g., name, resident registration number, etc.) of the marrying parties, preamble, and addendum. Moreover, the “Provisions” section can have the basic article (i.e., Article 1) only, and can additionally comprise a “Grounds for Divorce” button, a “Grounds for Happy Marriage” button, and a “View Case” button such that articles can be easily selected when adding articles. The function of each button has been described above.

In step 940, the prenuptial agreement preparing system 120 creates a draft for prenuptial agreement containing articles added in step 935. In step 945, the prenuptial agreement preparing system 120 creates the revised prenuptial agreement corresponding to the revision request received from the user terminal 110 and to the complementation request made by an administrator of the prenuptial agreement preparing system 120.

Once a request for confirmation on the revised prenuptial agreement (or the draft for prenuptial agreement) is received from the user terminal 110, the prenuptial agreement preparing system 120 adds a pre-designated certificate to the confirmed prenuptial agreement in step 950, and sends the confirmed prenuptial agreement to the e-mail address of the marrying parties or to the user terminal 110 through a communication network in step 955.

So far, examples of screen display in the process of preparing a prenuptial agreement based on the present invention have been described assuming that the screen displays are processed consecutively on a single screen. However, it should be apparent that these steps can be displayed on a separate screen or on a separate frame in the same screen. It is also possible to display the prepared prenuptial agreement on a screen that is separate from the process steps or on a separate frame in the same screen.

Moreover, although the description hereinbefore of a method and system for preparing a prenuptial agreement is based on the case of the parties planning to be married preparing the prenuptial agreement, the method and system can be equally applied when an old prenuptial agreement is to be revised, or a couple who are already married wish to prepare a prenuptial agreement for the first time based on their mutual experience. It should be also apparent that this invention can be applied to prevent irresponsibly moving in together and having a de facto marriage. In other words, more responsible cohabitation can be expected, not to mention that irresponsible separation can be prevented, by preparing a cohabitation agreement or a de facto marriage agreement before or during the cohabitation. Furthermore, the present invention can be applied to remove or ease the problems of asset division or child custody when the parties who have been divorced wish to be married again.

Although the description hereinbefore is based on using the same user terminal at the same time by the marrying parties, it is also possible that each marrying party uses an independent user terminal to access the prenuptial agreement preparing system simultaneously (or with a certain interval) and complete the prenuptial agreement. In this case, the user terminal of each marrying party can perform a P2P (peer-to-peer) access.

Moreover, the prenuptial agreement preparing service based on this invention charge one or both parties of the marrying parties for use of the service. It should be also apparent that payment for preparing a prenuptial agreement can be made by credit card, deposit without passbook, cyber money, and many other various means.

The accompanying drawings and detailed description are only an example of the present invention, serve only for describing the present invention, and by no means limit or restrict the spirit and scope of the present invention. Thus, any person of ordinary skill in the art shall understand that a large number of permutations and other embodiments are possible. The true scope of the present invention must be defined only by the spirit of the appended claims.

### INDUSTRIAL APPLICABILITY

As described above, a system and method for preparing a prenuptial agreement based on the present invention facilitates an on-line preparation of a prenuptial agreement comprising provisions for the marrying parties to pursue a happy marriage.

The present invention also allows a prenuptial agreement prepared by the marrying parties to be reviewed by a lawyer and certified by a law office to strengthen the reliability and prevent weakening of the commitment by each marrying party.

The present invention also allows the marrying parties to learn grounds for happy marriage beforehand and pursue a responsible marriage.

Moreover, a prenuptial agreement based on the present invention can be a foundation for executing asset division in case of divorce, if the agreement is certified by a lawyer's office.

Furthermore, the present invention can prevent irresponsible cohabitation or de facto marriage by teaching the responsibilities and obligations to those who are considering moving in together or starting a de facto marriage.

What is claimed is:

1. A method of preparing a prenuptial agreement in a prenuptial agreement preparing system connected to one or more user terminals through a communication network, the method comprising:
receiving a request for preparing a prenuptial agreement from one or more user terminals;
sending information for married life corresponding to a request for provision of information for married life, received from said user terminal, to said user terminal through a communication network;
receiving a request for provision of a proposed draft for prenuptial agreement from said user terminal;
sending a pre-stored proposed draft for prenuptial agreement to said user terminal;
receiving a request for insertion of articles from said user terminal;
creating a draft for prenuptial agreement by including articles corresponding to said request for insertion of articles to a proposed draft of prenuptial agreement;
sending said draft for prenuptial agreement to said user terminal;
receiving complementation or a request for revision from said user terminal on said draft for prenuptial agreement;
creating a revised draft for prenuptial agreement corresponding to said complementation or said revision request; and
sending said revised draft for prenuptial agreement to said user terminal.

2. The method of claim 1, further comprising:
receiving user verification information from said user terminal; and
inserting said user verification information to said draft for prenuptial agreement or said revised draft for prenuptial agreement;
wherein said user verification information comprises at least one of an electronic signature, user's facial image, iris recognition information, and finger print, and said user verification information is for two or more users.

3. The method of claim 1, further comprising:
receiving a request for confirmation of prenuptial agreement from said user terminal;
inserting a pre-stored certificate to said revised draft for prenuptial agreement corresponding to said request for confirmation of prenuptial agreement; and
sending a confirmed prenuptial agreement added with said certificate to said user terminal.

4. The method of claim 3, wherein the step of sending said confirmed prenuptial agreement to said user terminal sends said confirmed prenuptial agreement to a pre-designated e-mail address.

5. The method of claim 1, wherein the step of sending information corresponding to a request for provision of information for married life, received from said user terminal, to said user terminal through a communication network comprises:
sending a plurality of pre-stored sample grounds for divorce to said user terminal;
sending details corresponding to a selection of grounds for divorce, received from said user terminal, to said user terminal;
sending a plurality of pre-stored sample grounds for happy marriage, if a request for grounds for happy marriage is received from said user terminal; and
sending details corresponding to a selection of grounds for happy marriage, received from said user terminal, to said user terminal.

6. The method of claim 5, further comprising:
receiving selection information on any of said plurality of grounds for divorce and said plurality of grounds for happy marriage from said user terminal;
creating an attachment to prenuptial agreement, using sample grounds for divorce and sample grounds for happy marriage corresponding to said selection information; and
sending said created attachment to prenuptial agreement to said user terminal through a communication network.

7. The method of claim 1, wherein the step of receiving a request for insertion of articles from said user terminal comprises:
receiving a request for provision of articles from said user terminal;
sending one or more pre-stored articles to said user terminal through a communication terminal; and
receiving a request for insertion of articles corresponding to selection information received from said user terminal.

8. The method of claim 1, wherein a plurality of user terminals have a P2P (peer-to-peer) access.

9. The method of claim 3, further comprising:
receiving a request for revision on said confirmed prenuptial agreement from a user terminal;
updating said confirmed prenuptial agreement according to said request for revision; and
sending said updated confirmed prenuptial agreement to said user terminal.

10. A method of preparing a prenuptial agreement in a prenuptial agreement preparing system connected to one or more user terminals through a communication network, the method comprising:
receiving a request for preparing a prenuptial agreement and provision of a proposed draft for prenuptial agreement from one or more user terminals;
sending a pre-stored proposed draft for prenuptial agreement to said user terminal;
sending information for married life corresponding to a request for provision of information for married life, if said request for provision of information for married life is received from said user terminal, to said user terminal through a communication network, wherein said information for married life is at least one of sample grounds for divorce and sample grounds for happy marriage;
receiving a request for insertion of articles from said user terminal;
creating a draft for prenuptial agreement by including articles corresponding to said request for insertion of articles to said proposed draft for prenuptial agreement;
sending said draft for prenuptial agreement to said user terminal;
receiving complementation or a request for revision on said draft for prenuptial agreement from said user terminal;
creating a revised prenuptial agreement corresponding to said complementation or said revision request; and
sending said revised prenuptial agreement to said user terminal.

11. The method of claim 10, further comprising:
Receiving user verification information from said user terminal; and
Inserting said user verification information to said draft for prenuptial agreement or said revised prenuptial agreement;
wherein said user verification information comprises at least one of an electronic signature, user's facial image, iris recognition information, and finger print, and said user verification information is for two or more users.

12. The method of claim 10, further comprising:
Receiving a request for confirmation of prenuptial agreement from said user terminal;
Inserting a pre-stored certificate to said revised prenuptial agreement corresponding to said request for confirmation of prenuptial agreement; and
Sending a confirmed prenuptial agreement including said certificate to said user terminal.

13. A recorded medium for performing a method for preparing a prenuptial agreement, the medium having a program of instructions executable in a prenuptial agreement preparing server, the medium readable by said prenuptial agreement preparing server, the medium comprising the steps of:
Receiving a request for preparing a prenuptial agreement from one or more user terminals;
Sending information for married life corresponding to a request for provision of information for married life, received from said user terminal, to said user terminal through a communication network;
Receiving a request for provision of a proposed draft for prenuptial agreement from said user terminal;
Sending a pre-stored proposed draft for prenuptial agreement to said user terminal;
Receiving a request for insertion of articles from said user terminal;
Creating a draft for prenuptial agreement by including said articles corresponding to said request for insertion of articles in said proposed draft for prenuptial agreement;
Sending said draft for prenuptial agreement to said user terminal;
Receiving complementation or a request for revision from said user terminal on said draft for prenuptial agreement;
Creating a revised prenuptial agreement corresponding to said complementation or said request for revision; and
Sending said revised prenuptial agreement to said user terminal.
